(19) United States
(12) Patent Application Publication
(10) Pub. No.: US 2004/0140942 A1
(43) Pub. Date: Jul. 22, 2004

(54) Dual-polarized radiating assembly

(76) Inventor: Maximilian Gottl, Frasdorf (DE)

Correspondence Address: NIXON & VANDERHYE, PC, 1100 N GLEBE ROAD, 8TH FLOOR, ARLINGTON, VA, 22201-4714, US

(21) Appl. No.: 10/433,574

(22) PCT Filed: Jan. 23, 2003
(86) PCT No.: PCT/EP03/00703

(30) Foreign Application Priority Data
Jan. 31, 2002 (DE) 102 03 873.2

(51) Int. Cl. H01Q 21/00

(52) U.S. Cl. 343/810

(57) ABSTRACT

An improved dual-polarized antenna arrangement is distinguished in particular by the following features:

the four antenna element devices (1, 1′) each have a conductive structure between their opposite antenna element ends (9),

those antenna element ends (9) of two adjacent antenna element devices (1, 1′) which are in each case adjacent to one another are in each case isolated from one another for radio frequency purposes,

those antenna element ends (9) of two adjacent antenna element devices (1, 1′) which are in each case located adjacent to one another in pairs form feed points (113), and

the antenna element devices (1, 1′) are fed at least approximately in phase and approximately symmetrically between the respective opposite feed points (113).

The invention relates to a dual-polarized antenna element arrangement, in particular for the field of mobile radio, as claimed in the precharacterizing clause of claim 1.

Dual-polarized antennas in the field of mobile radio are preferably used at 800-1000 MHz and 1700-2200 MHz. In this case, an antenna produces two orthogonal polarizations, and, in particular, the use of two linear polarizations aligned at +45° and −45° with respect to the vertical has been proven (X polarization). In order to optimize the illumination of the supply area, antennas with different horizontal 3 dB beam widths are used with 3 dB beam widths of 65° and 90° having been implemented as a sensible step.

For antennas with only one polarization, there are a number of solutions according to the prior art for providing these different 3 dB beam widths.

Thus, for example, simple vertically aligned dipoles with a reflector that is optimized for the appropriate 3 dB beam width are used as vertically polarized antennas. For antennas for only one operating frequency band, solutions for X-polarized antennas with 3 dB beam widths of 90° have likewise already become known. Cruciform dipoles, dipole squares or patch antenna elements with an appropriately designed reflector are used, by way of example, for this purpose, in order to achieve an appropriate horizontal 3 dB beam width.

According to DE 197 22 742 A1, a reflector geometry is proposed for this purpose in which slots are incorporated in the reflector side boundaries which project laterally beyond the reflector plate. If a reflector geometry such as this is used, for example, for cruciform dipoles or for a specific dipole structure such as that which is known by way of example from DE 198 60 121 A1, then a horizontal 3 dB beam width of between about 85° and 90° can be achieved. However, this example relates only to an antenna which is operated in only one operating frequency band.

However, in the case of dual-polarized antennas which are intended to be operated in two frequency bands that are well apart from one another and which are offset, for example, by a factor of 2:1 from one another, solutions are known only with horizontal 3 dB beam widths of about 65°.

By way of example DE 198 23 749 in this context proposes a combination of dipole antenna elements, allowing a 3 dB beam width of about 65° to be achieved for the two frequency bands (for example the 900 MHz band and the 1800 MHz band).

A corresponding solution using patch antenna elements is known, for example, from WO 00/01 032.

It has not yet been possible to produce antennas which can be operated in two frequency bands or in two operating frequency ranges and at the same time are intended to have a 3 dB beam width of about 90°.

Furthermore, reference is also made to further prior publications relating to antennas which, however, are likewise not suitable for operation with a 3 dB beam width of about 90° in two frequency bands that are offset with respect to one another. By way of example, these are antennas such as those described in the publication S. Maxi and Biffi Gentili: “Dual-Frequency Patch Antennas” in: IEEE Antennas and Propagation Magazine, Vol. 39, No. 6, December 1997. A dual polarized antenna which has a triple structure and whose polarization is aligned horizontally and vertically is also known from Nobuhiro Koga: “A Notch-Wire Composite Antenna for Polarization Diversity Reception” in IEEE AP Vol. 46, No. 5, June 1998 pages 902-906. This antenna produces an omnidirectional polar diagram. However, this does not relate to a dual-band antenna which has a horizontal 3 dB beam width of about 90°.

The object of the invention is thus to provide an antenna element arrangement which, firstly, can be used for two orthogonal polarizations and in which at least one antenna element can be integrated for a higher frequency band range, with the aim of being able to achieve 3 dB beam widths of about 90°.

According to the invention, the object is achieved by the features specified in claim 1 or 2. Advantageous refinements of the invention are specified in the dependent claims.

The dual-polarized antenna element arrangment according to the invention for the first time makes it possible to construct antennas which have horizontal 3 dB beam widths of 90° in both frequency bands. Independently of this, these antenna element structures may, however, also be used for operation in only one frequency band, if required.

The invention will be described in the following text with reference to drawings in which, in detail:

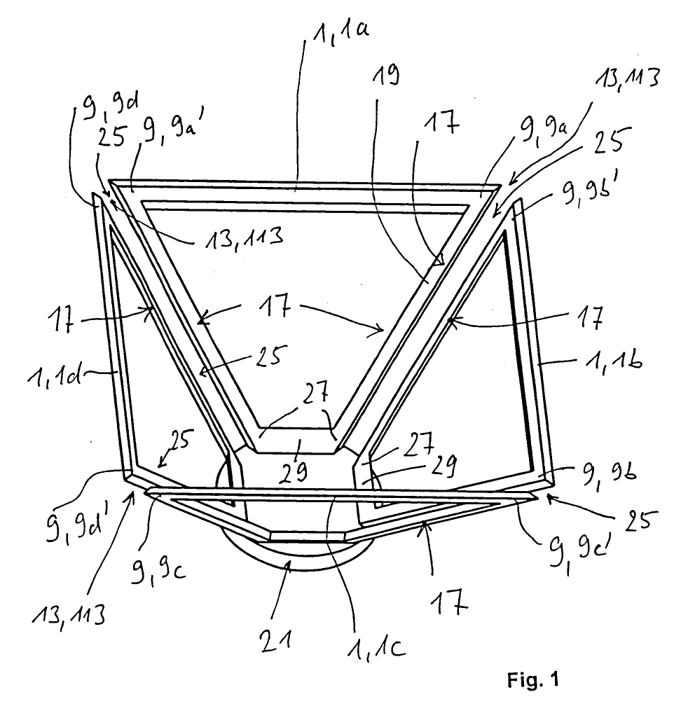

FIG. 1: shows a schematic perspective illustration of a dual-polarized antenna element arrangement according to the invention;

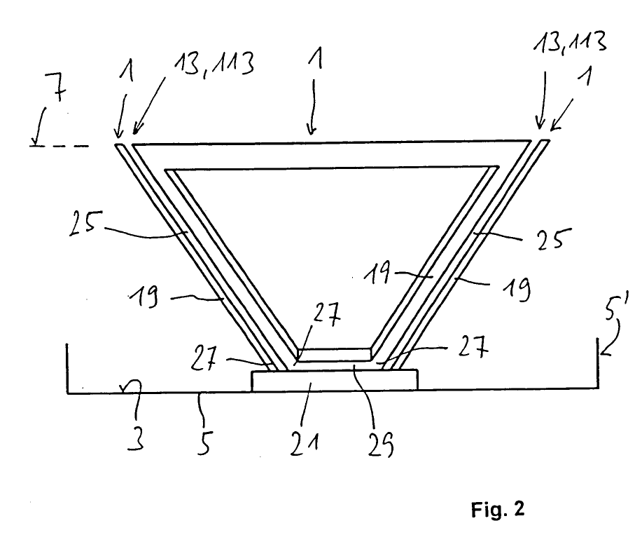

FIG. 2: shows a schematic side view of the antenna element arrangement illustrated in the form of a perspective illustration in FIG. 1, in the form of a cross section at right angles through the reflector plane;

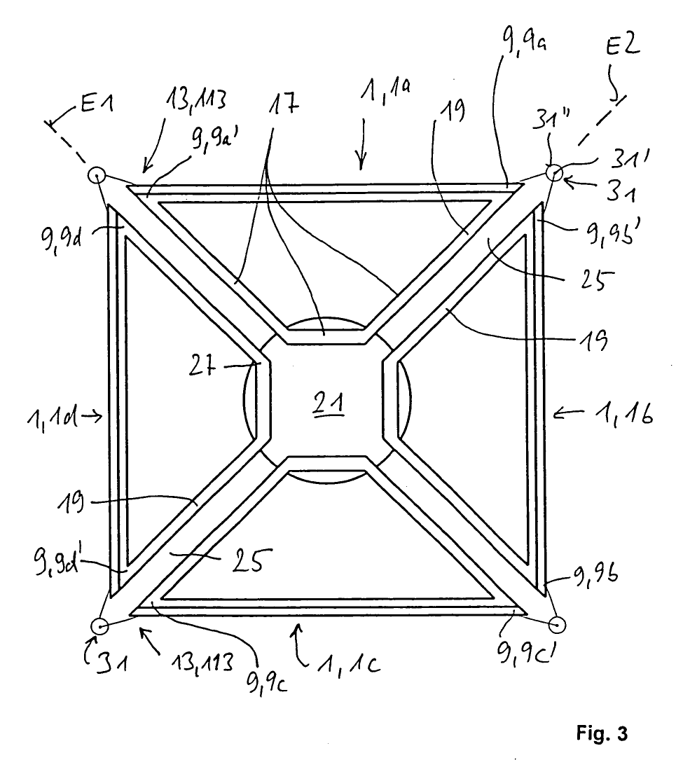

FIG. 3: shows a schematic plan view of the exemplary embodiment shown in FIGS 1 and 2;

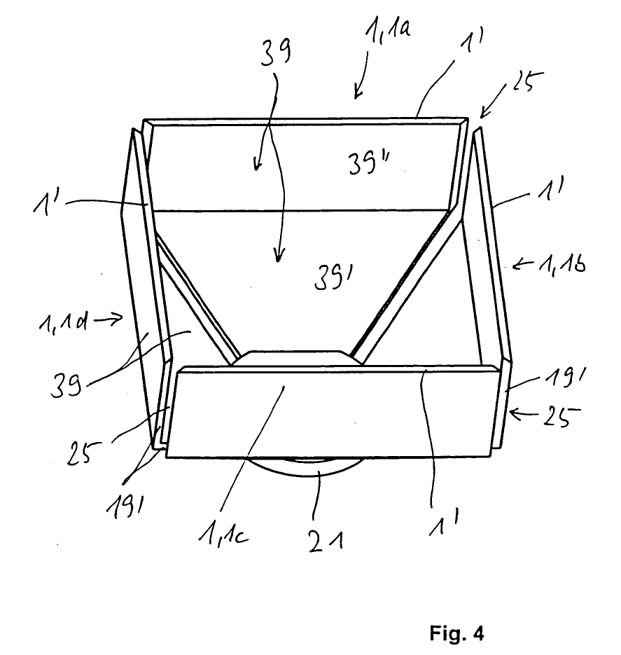

FIG. 4: shows a schematic perspective illustration of a modified exemplary embodiment of an an antenna element arrangement;

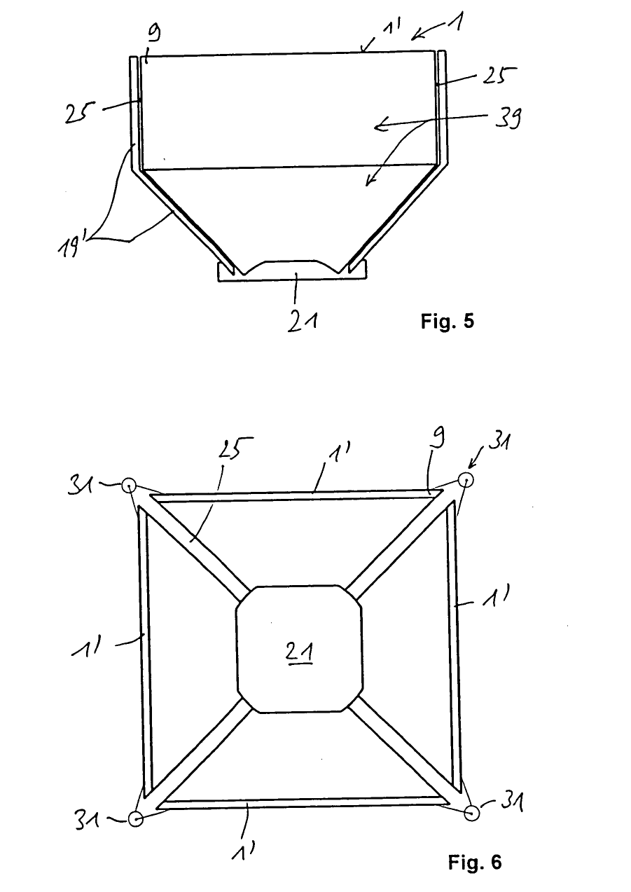

FIG. 5: shows a side view of the exemplary embodiment shown in FIG. 4;

FIG. 6: shows a plan view of the exemplary embodiment shown in FIGS. 4 and 5;

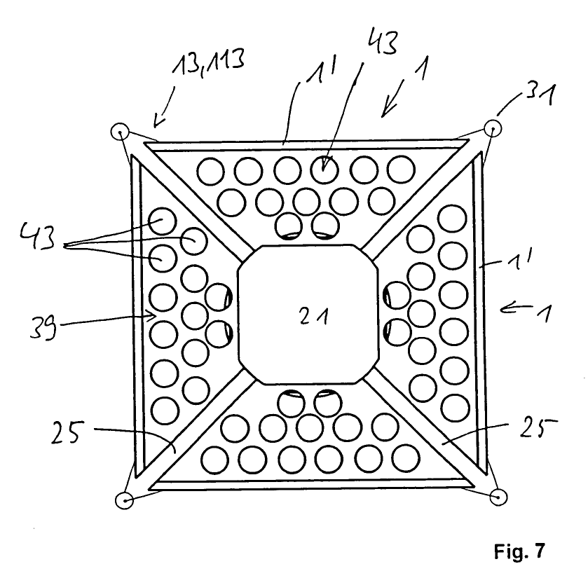

FIG. 7: shows a plan view, corresponding to FIG. 6, of a modified exemplary embodiment with a hole grid as antenna element arrangements;

FIG. 8: shows a plan view of a further modified exemplary embodiment with convex-shaped antenna element arrangements;

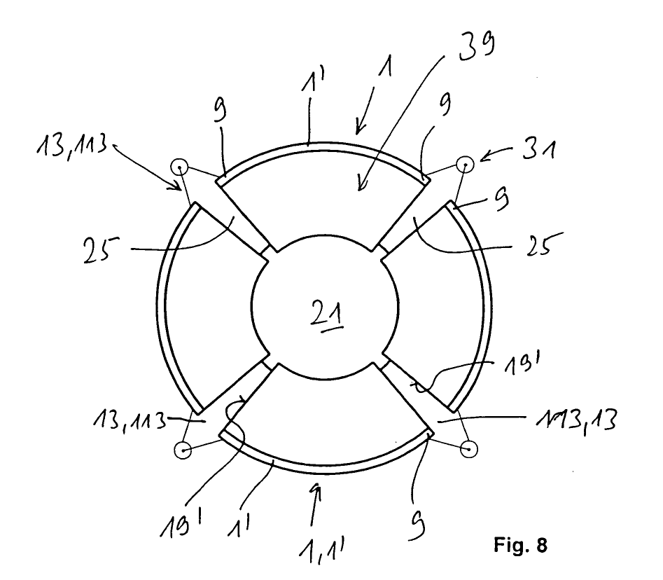

FIG. 9: shows a further modified exemplary embodiment in the form of a schematic plan view, with concave-shaped antenna element arrangements;

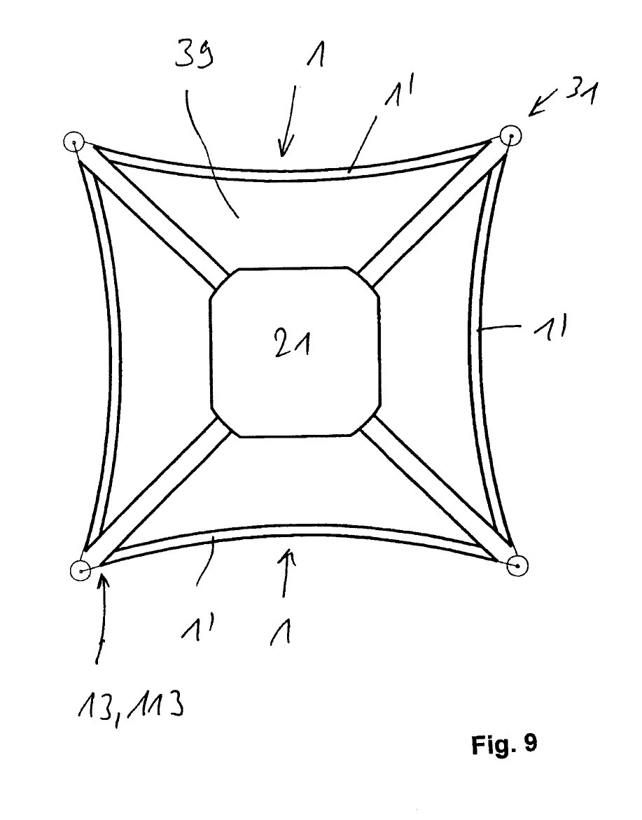

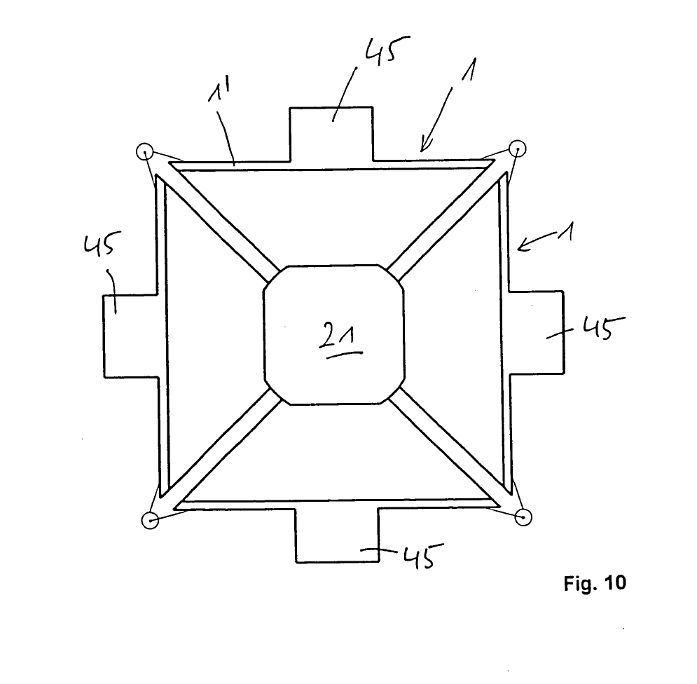

FIG. 10: shows a schematic plan view of another modified exemplary embodiment, with antenna element attachments at the side;

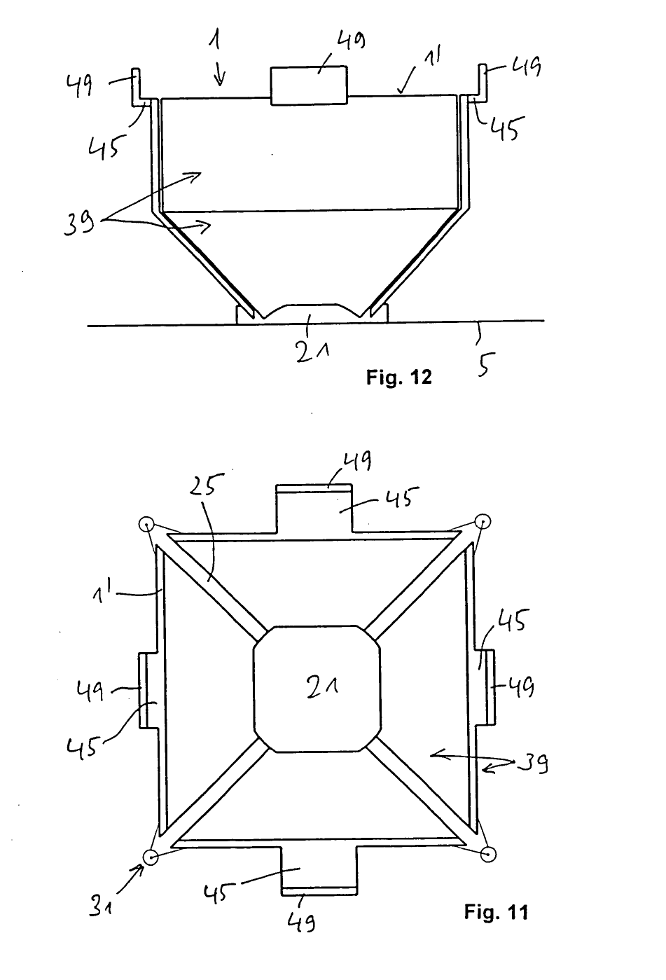

FIG. 11: shows a plan view of a further development of the exemplary embodimen shown in FIG. 10, with protruding prejections running at right angles to the extension attachments;

FIG. 12: shows a side view of the exemplary embodiment shown in FIG. 11;

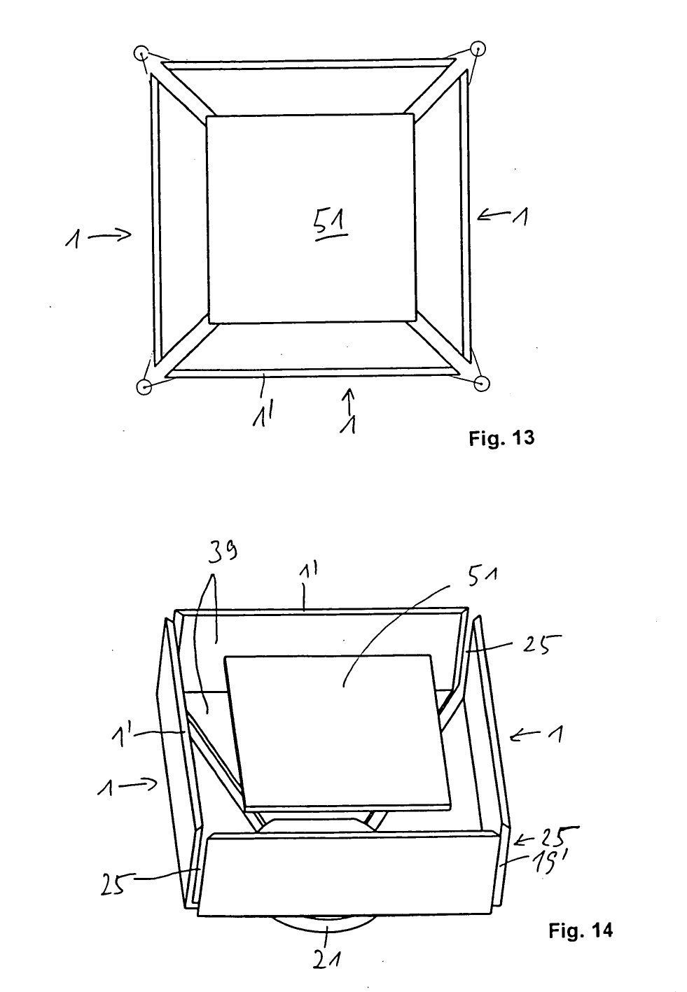

FIG. 13: shows a schematic plan view of a dual-polarized two-band antenna element arrangement with an internal patch antenna element for the higher frequency;

FIG. 14: shows a perspective illustration of the antenna element arrangement shown in FIG. 13;

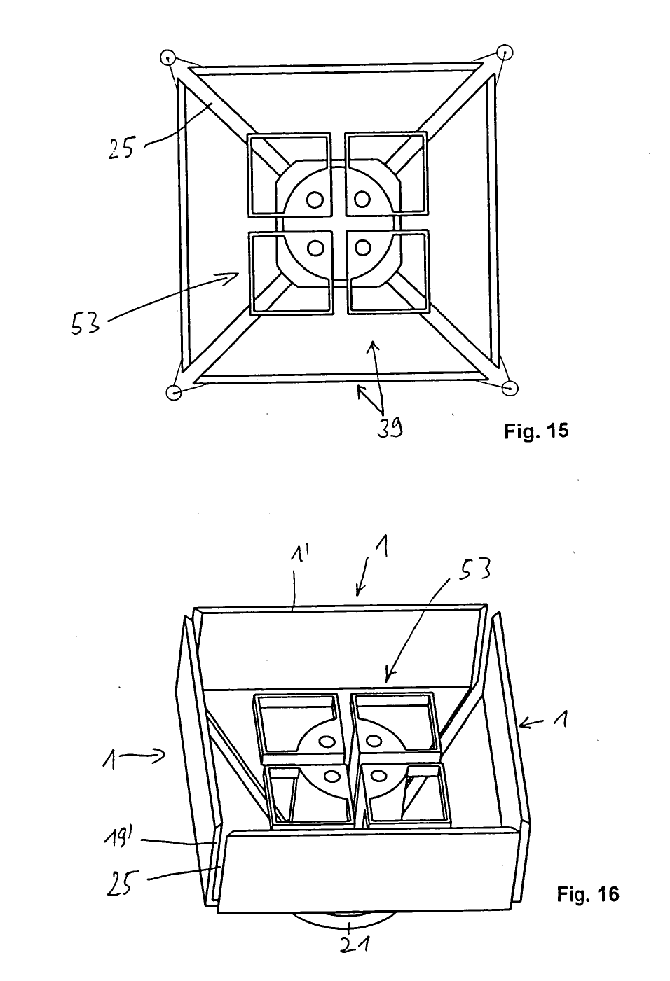

FIG. 15: shows a schematic plan view of an antenna element arrangement that has been modified from that in FIG. 13; and

FIG. 16: shows a schematic perspective illustration of the exemplary embodiment shown in FIG. 15.

FIGS. 1 to 3 show a first exemplary embodiment of a dual-polarized antenna according to the invention.

As can be seen from the perspective illustration in FIG. 1, from the schematic side view in FIG. 2 (in the form of a sectional illustration at right angles through the reflector plane) and from a plan view in FIG. 3, the antenna element arrangement according to the invention essentially has four antenna element devices 1, that is to say four antenna element devices 1a, 1b, 1c and 1d, which are conductive. These four antenna element devices 1 form a structure whose plan view has a square shape. In other words, the antenna with the antenna element arrangement as explained is constructed to be rotationally symmetrical or point-symmetrical about 90°.

The antenna element devices 1 which form a square structure in a plan view may in this case also be referred to as antenna elements, antenna element arms, antenna element rods or, in general, as antenna element structures.

These four antenna element devices 1 which are in the form or rods in the illustrated exemplary embodiment shown in FIGS. 1 to 3 have approximately the same length, of about 0.2 times the operating wavelength λ to the operating wavelength λ itself. The distance from the plane 3 of the reflector 5 is approximately ⅛ to ¼ of the operating wavelength.

It is thus evident from the described configuration that the antenna element devices 1 which are in the form of rods in the described exemplary embodiment are arranged in a common antenna element plane 7, parallel to the reflector plane. In this case, the respectively opposite antenna element devices 1, that is to say in the described exemplary embodiment, the antenna element devices 1a and 1c, are parallel to one another. Furthermore, the two further antenna element devices which are each offset through 90°, that is to say in the described exemplary embodiment the antenna element devices 1b and 1d, are likewise arranged parallel to one another. Both pairs of mutually parallel antenna element devices 1a and 1c on the one hand and 1b and 1d on the other hand are aligned at right angles to one another or at least approximately at right angles to one another, thus resulting in an antenna arrangement which can transmit and receive using two mutually perpendicular polarizations, to be precise in a plane E1 which is aligned at an angle of +45° to the horizontal, and in a plane E2 which is aligned at an angle of −45° to the horizontal.

As can likewise be seen from the exemplary embodiment, the respectively opposite ends 9, that is to say the ends 9 which are remote from one another, of the four antenna element devices 1, that is to say the antenna element ends 9a, 9a′ and 9b, 9b′, as well as 9c, 9c′ and 9d, 9d′, are isolated for radio frequency purposes from the respectively adjacent end point of the adjacent antenna element device. This means that the antenna element end 9a is isolated from the adjacent antenna element end 9b′, the antenna element end 9b is isolated from the adjacent antenna element end 9c′, the antenna element end 9c is isolated from the adjacent antenna element end 9d′ and the antenna element end 9d is isolated from the adjacent antenna element end 9a′, for radio frequency purposes. Each of the four antenna element devices 1 is held and supported by an electrically conductive holding device 17, preferably with respect to the reflector 5. This holding device 17 in the exemplary embodiment shown in FIGS. 1 to 3 may in each case be formed from two rods or a rod device 19 for each antenna element device 1, which rods or rod device 19 are or is passed to the antenna element devices 1, in a diverging form to the antenna element ends 9, from a base 21 which is preferably formed by the reflector and to which they or it are or is mechanically mounted and fitted in an electrically conductive manner. The arrangement in this case comprises the rod devices 19 (which are in each case passed to the adjacent antenna element ends, for example to the antenna element ends 9a and 9b′ of the antenna element devices 1a and 1b that are arranged adjacent to one another) running from their base 21 parallel and at a distance from one another, so that a slot or gap 25 is in each case formed between two adjacent rods or rod arrangements 19.

Firstly, as can be seen from the described configuration, the rods or rod device 19 are or is connected to one another at the reflector-side or base-side end 27 via a conductive base 21, the conductive reflector plate 5 and/or a conductive connection 29. As stated, a cable connection to the reflector 5 itself is additionally preferably produced in this case. This cable connection to the reflector 5 need not necessary be provided, however.

An approximately trapezoidal structure is thus formed in the case of the exemplary embodiment explained with reference to FIGS. 1 to 3 by the respective antenna element device 1, the rod or holding device 17, 19 which leads to the respective antenna element ends of the antenna element device 1, and the base-side or reflector-side ends 27, as well as by the conductive connecting devices 29 which may be provided between them and/or a conductive base, or by the reflector 5 itself.

In this exemplary embodiment, the antenna element devices 1 are fed at the respective end of the four gaps or slots 25, that is to say at the antenna element ends 9. They are thus in this case fed at these four corners or points 13, preferably by means of coaxial cables 31 which are indicated schematically in the schematic plan view shown in FIG. 2.

In this case, each of the inner conductors 31′ is electrically connected to one end of one antenna element device 1, and the outer conductor 31″ is electrically connected to the adjacent end of the adjacent antenna element device 1. Thus, in other words, the outer conductor 31″ of the coaxial cable 31 is, for example, electrically connected to the antenna element end 9a of the antenna element device 1a while, in contrast, the inner conductor 31′ is electrically connected to the adjacent antenna element end 9b′ of the adjacent antenna element device 1b.

Feed points 113 are thus in each case formed at the ends 9 (which are located adjacent to one another in pairs) of the antenna element devices 1, that is to say at the four points or corners 13 that have been mentioned, with the antenna element arrangement in each case being fed in phase at these feed points, that is to say at the respectively diametrically opposite points or corners at that end of the slots or gaps 25 which is remote from the reflector, that is to say at the feed points 113 which have been mentioned at the respective gap end. This may be done, for example, by connecting them together by means of a coaxial cable of equal length from a central feed point. This thus results in two central feed points 35a and 35b for each of the orthogonal polarizations which, at the same time, have a high degree of decoupling between them. Since the rods or rod device 19 of the holding device 17 and hence the slots or gaps 25 have or has a length of λ/4, the antenna element ends 9 can be short-circuited without any problems at the base end or reflector end. In this example, they thus act as a balancing device, together with the feed cables.

The schematic cross-sectional illustration in FIG. 2 shows a cross section of the reflector which may have side boundary walls 5′ which run externally, as well as transversely or at right angles to the reflector plane 3.

The following text refers to a next exemplary embodiment.

A further exemplary embodiment will be described with reference to FIGS. 4 and 5. This exemplary embodiment differs from that shown in FIGS. 1 to 3 in that the surface which is bounded by the respective antenna element device 1 and by the rods or rod devices 19 (which act at the side on the ends of the antenna element devices 1) and by the base 21 to which the rods 19 are fitted, as well as, if appropriate, by the reflector 5 and/or by the conductive connecting elements 29 which have been mentioned, is not free or left empty but is configured as an electrically complete surface and hence as a closed surface. This thus results in four antenna element devices 1 or antenna element structures 1 which each have a closed surface element 39. The boundary edge 1′ that is in each case located at the top of this surface element 39 represents the antenna element device 1, in a comparable way to the exemplary embodiment shown in FIGS. 1 to 3. The side boundary edges 19′ in the end represent the rods or rod device 19 which bound or bounds the associated slot or the associated gap 25. The edge 27′ which is located at the bottom is comparable to the connecting element 28 on the base side or reflector side.

A further difference between the exemplary embodiment shown in FIGS. 4 to 6 and that in the exemplary embodiment shown in FIGS. 1 to 3 is that the surface elements 39 are positioned on edge in the vertical sectional illustration, the lower section 39′, on the base side or reflector side, of the surface element runs in a slightly divergent manner outward starting from a central section (for example at an angle of 20° to 70°, preferably of 30° to 60° and in particular of 45°, [sic] while in contrast only one outer section 39″, which is at a distance from the reflector, of the respective surface element 39 is aligned in the vertical direction, that is to say at right angles to the reflector 5. This makes it possible for the entire length of the slot or gap 25, and hence the entire length of boundary edges 19′ which are comparable to the holding rod 19 shown in FIG. 1 likewise once again to be λ/4 of the operating frequency (preferably of the mid-operating frequency) so that the surface elements 39 can produce a short circuit on the base side or reflector side between the radiating boundary edges 19′ which are located at the top and run parallel to the reflector, thus forming the actual antenna element devices 1. To this extent, the exemplary embodiment shown in FIG. 2 also shows that, of course, the exemplary embodiment shown in FIG. 1 need not have rods or rod devices 19 running in a straight line but that, even in the case of the exemplary embodiment shown in FIGS. 1 to 3, the rods or rod devices may, while having a parallel profile with respect to one another, have a kinked shape, comparable to the edge 19′ in the exemplary embodiment shown in FIGS. 3 to 5, forming a slot 25.

The overall height of an antenna element formed in this way is less due to this kinked configuration of the individual surface elements 39.

The embodiment shown in FIGS. 4 to 6 may thus also be configured such that only rectangular surface elements 39″ which are open at the top are provided, instead of the lower surface elements 39′, which each form a trapezoidal shape when seen in a plan view, [lacuna] apertures, with the upper surface elements 39′, then being held by side supporting elements 19.

The schematic plan view shown in FIG. 7 illustrates only that the surface elements 39 need not be designed to be closed over the complete area, in contrast to the situation in the last-explained exemplary embodiment, but may also, for example, be provided with a hole grid 43. Further modified forms are possible and feasible as required.

An overall structure in which the individual antenna element devices 1 are not in the form of rods or boundary edges running in straight lines but form convex or even partially circular antenna element devices 1 when seen in a plan view, was chosen for the exemplary embodiment shown in FIG. 8. If the slots or gaps 25 that are located opposite one another in a cruciform manner were not bounded by holding rods or rod devices 19, but these edges 19′ were part of surface elements 39 that were located offset through 90°, then these would likewise be configured running in a corresponding manner aligned in the form of partial truncated cones or partial cylinders.

In one exemplary embodiment, shown in FIG. 9, the antenna element devices 1 have a concave shape rather than a convex shape. In this exemplary embodiment as well, the antenna element device 1 which is located at the top could otherwise once again be in the form of an electrically conductive device in the form of a rod or the like, held by corresponding rods or rod devices 19. The free surface in between may, however, once again be closed over the complete surface as well, so that surface elements 39 are formed, comparable to the exemplary embodiment shown in FIGS. 4 and 5.

It can thus be seen in particular from FIGS. 8 and 9 that the antenna element devices 1, for example when using appropriate surface elements 39, may have the antenna element edges 1′ which not only run in straight lines between the feed points 13, 113 but, when seen in a plan view from a central center section, are shaped such that they project outward in a convex shape or even in a concave shape. Appropriately shaped antenna element devices 1 may be used in this case, or alternatively full-area or partially full-area antenna elements 1 with surface sections 39, or forming a corresponding free space 39′.

In addition, FIG. 10 will be used to explain how an improvement in the polar diagram characteristic can also be achieved by the capability to provide projecting lugs or attachments 45, which are electrically conductively connected and project such that they run outward preferably centrally and aligned parallel to the reflector 5, on the antenna element devices 1, which may be in the form of rods, or in the case of surface elements 39 on the corresponding boundary edges 1′ which form the actual antenna element devices 1.

In the exemplary embodiment shown in FIGS. 11 and 12, a further extension 49 is also provided at the outer ends 47 of these lugs or attachments 45 and, in this exemplary embodiment, is once again preferably aligned vertically with respect to the reflector plane 3. In this case, the plan view in FIG. 11 also shows that the lugs or attachments 45, which are each located in pairs with an offset of 90° between them and preferably run parallel to the reflector plane 3, may run with a different longitudinal extent along the reflector plane. The same also applies to the extension attachments 49 which are preferably provided vertically with respect to the reflector plane 3.

A dual-polarized antenna has therefore been described with reference to the explained exemplary embodiments, that is to say an antenna element arrangement which operates in one frequency band and in this case may have wide 3 dB beam widths of, for example, around 90°.

In this case, for example, two or more such antenna element arrangements, as explained with reference to FIGS. 1 to 11, may be arranged vertically one above the other, preferably in front of a common reflector 3. If the antenna element devices 1 or boundary edges 1′ which have been mentioned are arranged horizontally and/or vertically with respect to one another in a corresponding manner to the exemplary embodiments which have been explained, then this results in an X-polarized antenna, in which one polarization is aligned at +45° to the horizontal plane, and the other polarization is aligned at −45° to the horizontal plane. Thus, in a plan view, the polarization directions match the profile of the slots or gaps 25.

However, in an extended antenna structure, it is now possible to construct an entire antenna arrangement which is also suitable for operation in two frequency bands or frequency ranges, which are separated from one another and, for example, differ by a factor of 2:1. Thus, in other words, it is possible to construct an antenna which, for example, can be operated in a 900 MHz frequency band and in an 1800 MHz frequency band or, for example, in a 900 MHz frequency band and in a 2000 MHz or 2100 MHz frequency band.

The exemplary embodiment shown in FIGS. 13 and 14 illustrates a further antenna element arrangement for operation at a higher frequency band being provided in the interior of the dual-polarized antenna element arrangement that has been explained with reference to FIGS. 1 to 11.

In the exemplary embodiment shown in FIGS. 13 and 14, this is provided by a patch antenna 51 which, in a plan view, has a square structure by way of example and, in this case, may be located at approximately the same height as the boundary edges 1′, that is to say at the same height as the antenna element devices 1.

In the exemplary embodiment shown in FIGS. 15 and 16, a vector dipole arrangement 53 is used for operation in the higher frequency band, as is in principle known from DE 198 60 121 A1, whose entire disclosure content is referred to and is included in the content of this application. In this vector dipole element 53, the dipole halves are each physically formed from two half dipole components aligned at right angles to one another, with the ends of the cables which lead to the respective dipole halves and are symmetrical or are essentially or approximately symmetrical being connected such that the corresponding cable halves of the adjacent dipole halves which are at right angles to one another are always electrically connected. The respectively diametrically opposite dipole halves are electrically fed for a first polarization, and are decoupled from a mutually orthogonal second polarization. The inner antenna element as shown in FIGS. 15 and 16 in the form of a vector dipole 53 as has been explained is thus also suitable for transmitting or receiving X-aligned polarizations, that is to say a +45° and −45° with respect to the aligned polarizations. In other words, the polarization of the inner vector dipole 53 and of the outer antenna element, which is designed to be wedge-shaped from bottom to top, are parallel.

In contrast to the exemplary embodiments which have already been explained, other combinations of antenna element types are, of course, also feasible, for example cruciform dipoles, which may be used for the purposes of the invention.

1. A dual-polarized antenna element arrangement, which is preferably arranged in front of a reflector or in front of a reflector arrangement (5) and has at least four conductive antenna element devices (1, 1′) which are each arranged offset through at least approximately 90° with respect to one another, with the four conductive antenna element devices (1, 1′) being mounted and held by means of a holder with respect to a base (21) or with respect to a reflector or a reflector arrangement (5), characterized by the following further features:
the four antenna element devices (1, 1′) each have a conductive structure between their opposite antenna element ends (9),
those antenna element ends (9) of two adjacent antenna element devices (1, 1′) which are in each case adjacent to one another are in each case isolated from one another for radio frequency purposes,
those antenna element ends (9) of two adjacent antenna element devices (1, 1′) which are in each case located adjacent to one another in pairs form feed points (113), and
the antenna element devices (1, 1′) are fed at least approximately in phase and approximately symmetrically between the respective opposite feed points (113).

2. A dual-polarized antenna element arrangement, which is preferably arranged in front of a reflector or in front of a reflector arrangement (5) and has at least four conductive antenna element devices (1, 1′) which are each arranged offset through at least approximately 90° with respect to one another, with the four conductive antenna element devices (1, 1′) being mounted and held by means of a holder with respect to a base (21) or with respect to a reflector or a reflector arrangement (5), in particular as claimed in claim 1, characterized by the following further features:
the antenna element devices (1, 1′), which in plan view are located offset through approximately 90° in the circumferential direction with respect to one another in each case form a slot or gap (25) between them,
the slot or gap (25) in each case has a feed point (113) at a point (13) which is located remotely from a reflector or from a reflector arrangement (5) or from a base (21) and is isolated for radio frequency purposes,
the maximum distance, projected onto the reflector or onto the reflector arrangement (5), between in each case two opposite antenna element devices (1, 1′) is equal to or greater than ¼ of the wavelength of the operating frequency band, and
the antenna elements (1, 1′) have feed points (13, 113) at which the antenna elements (1, 1′) are fed at least approximately in phase or at least approximately symmetrically, with the feed points (13, 113) being formed by those ends (9) of in each case two adjacent antenna elements (1, 1′) which are adjacent to one another in pairs.

3. The dual-polarized antenna element arrangement as claimed in claim 1 or 2, characterized in that the antenna element devices (1, 1′) are each held and/or mounted by means of an electrically conductive holder (17) with respect to a base (21) or a reflector or a reflector arrangement (5), and in that a slot or gap (25), which runs from the base (21) or the reflector or the reflector arrangement (5) to the feed point (113) is formed between the electrically conductive holding device (17) of in each case one antenna element device (1, 1′) and the holding device (17) of an adjacent antenna element device (1, 1′).

4. The dual-polarized antenna element arrangement as claimed in claim 3, characterized in that the holder (17) for an antenna element device (1, 1′) is also formed from at least two rods or at least two rod devices (19), with the at least two rods or rod devices (19) originating from the respective antenna element end (9) of an antenna element device (1, 1′), and leading to a mounting point and/or end point at a base-side and/or reflector-side end (27).

5. The dual-polarized antenna element arrangement as claimed in one of claims 1 to 4, characterized in that the slots or gaps (25) between two adjacent holding devices (17) or rods or rod devices (19) have at least approximately the same width over the entire length.

6. The dual-polarized antenna element arrangement as claimed in one of claims 1 to 5, characterized in that the length of the slots or gaps (25) corresponds to approximately ¼ of the operating wavelength.

7. The dual-polarized antenna element arrangement as claimed in one of claims 1 to 6, characterized in that the holding device (17) of the antenna element devices (1, 1′) or the slots or gaps (25) which are formed between the holding devices (17) are short-circuited on the base side and, in particular, on the reflector side.

8. The dual-polarized antenna element arrangement as claimed in one of the preceding claims 1 to 7, characterized in that the length of the individual antenna element devices (1, 1′) corresponds to approximately 0.2 times the wavelength to the wavelength itself at a mid-operating frequency.

9. The dual-polarized antenna element arrangement as claimed in one of claims 1 to 8, characterized in that the antenna element devices (1, 1′) and the rods or rod devices (19) which originate from the opposite antenna element ends (9), and the connecting element (28) which is provided on the base side and/or reflector side, or the boundary plane (3) is [sic] in the form of a free surface (39′).

10. The dual-polarized antenna element arrangement as claimed in one of claims 1 to 8, characterized in that the antenna element devices (1, 1′) and the rods or rod devices (19) which originate from the opposite antenna element ends (9), and the connecting element (28) which is provided on the base side and/or reflector side, or the boundary plane (3) is [sic] designed to be conductive over the entire area.

11. The dual-polarized antenna element arrangement as claimed in claim 10, characterized in that the antenna element device (1, 1′) is formed with a supporting holding device (17) as an element over the entire area, possibly with a large number of regular or irregular apertures, openings, in the form of a grid or the like.

12. The dual-polarized antenna element arrangement as claimed in one of claims 1 to 11, characterized in that the holding device (17) is preferably in the form of rods or rod devices (19), and/or is designed to run in a straight line in a vertical sectional illustration, as an electrical element which is closed over the entire area or over part of the area.

13. The dual-polarized antenna element arrangement as claimed in one of claims 1 to 11, characterized in that the holding device (17) is preferably in the form of rods or rod devices (19), and/or is designed to be kinked or curved, that is to say in general to change the direction profile, in a vertical sectional illustration as an electrical element which is closed over the entire area or over part of the area.

14. The dual-polarized antenna element arrangement as claimed in claim 13, characterized in that that section of the holding device (17) which is located closer to the base side or reflector side is aligned such that, in a vertical sectional illustration, it runs in an angle range from 20° to 70°, preferably 30° to 60°, and in particular around 45° diverging outward over the base or over a reflector or a reflector arrangement (5).

15. The dual-polarized antenna element arrangement as claimed in claim 13 or 14, characterized in that at least one section of the holding device (17) which is on the outside and is located further away from the base (21) or from a reflector (5) runs such that it is preferably aligned at least approximately vertically with respect to a base (21) or a reflector or a reflector arrangement (5).

16. The dual-polarized antenna element arrangement as claimed in one of claims 1 to 15, characterized in that the antenna element devices (1, 1′) are designed to have an at least approximately square plan view, if appropriate including the holding device (17).

17. The dual-polarized antenna element arrangement as claimed in one of claims 1 to 15, characterized in that the antenna element devices (1, 1′) are designed to have an at least approximately convex or preferably circular overall plan view, if appropriate including the holding device (17).

18. The dual-polarized antenna element arrangement as claimed in one of claims 1 to 15, characterized in that the antenna element devices (1, 1′) have antenna element devices (1, 1′) which have a concave-shaped plan view, if appropriate including the holding device (17).

19. The dual-polarized antenna element arrangement as claimed in one of claims 1 to 18, characterized in that attachments or lugs (45), which preferably project outward in pairs opposite one another, are formed on the antenna element devices (1, 1′).

20. The dual-polarized antenna element arrangement as claimed in claim 19, characterized in that lengthening attachments (49) are formed on the attachments or lugs (45) which project outward, pointing away from the base or the reflector or the reflector arrangement (5).

21. The dual-polarized antenna element arrangement as claimed in one of claims 1 to 20, characterized in that the antenna element arrangement (1, 1′) has a cup-shaped structure.

22. The dual-polarized antenna element arrangement as claimed in one of claims 1 to 21, characterized in that a further antenna element arrangement (50) for operation in a further frequency band is arranged in the interior of the antenna element arrangement (1, 1′) in a plan view.

23. The dual-polarized antenna element arrangement as claimed in claim 22, characterized in that the further antenna element arrangement (50) for operation in a further higher frequency band is in the form of a patch antenna element (51).

24. The dual-polarized antenna elements arrangement as claimed in claim 22, characterized in that the further antenna element arrangement (50) for operation in a further higher frequency band is in the form of a cruciform dipole.

25. The dual-polarized antenna element arrangement as claimed in claim 22, characterized in that the further antenna element arrangement for operation in a further higher frequency band is in the form of a dipole square.

26. The dual-polarized antenna element arrangement as claimed in claim 22, characterized in that the further antenna element arrangement for operation in a further higher frequency band is in the form of a vector dipole (53).

27. The dual-polarized antenna element arrangement as claimed in one of claims 1 to 26, characterized in that two opposite feed points (113) are in each case connected together via a coaxial line of at least approximately the same length to form a central feed point, with the one set of opposite feed points (113) which are connected together in pairs being used to feed one polarization, and the two further feed points (113) which are connected together and are offset through 90° with respect to the first being used to feed the respective other polarization.

28. The dual-polarized antenna element arrangement as claimed in one of claims 1 to 27, characterized in that four antenna element devices (1, 1′) are provided and, in a plan view, are arranged at least approximately symmetrically about a center point.

29. The dual-polarized antenna element arrangement as claimed in one of claims 1 to 28, characterized in that the maximum distance between in each case two opposite antenna element arrangements (1, 1′) is less than or equal to the wavelength λ of the operating frequency band.

30. The dual-polarized antenna element arrangement as claimed in one of claims 1 to 29, characterized in that the length of the antenna element devices (1, 1′) is less than or equal to the wavelength λ of the operating frequency band.
